(19) United States
(12) Patent Application Publication
(10) Pub. No.: US 2019/0369849 A1
(43) Pub. Date: Dec. 5, 2019

(54) Visualizing Execution History With Shader Debuggers

(71) Applicant: Apple Inc., Cupertino, CA (US)

(72) Inventors: Xavier Verguin Gonzalez, Mountain View, CA (US); Andrew M. Sowerby, San Francisco, CA (US); Alp Yucebilgin, San Mateo, CA (US); Maximilian Christ, Sunnyvale, CA (US); Ubaka C. Onyechi, London (GB)

(21) Appl. No.: 15/996,327

(22) Filed: Jun. 1, 2018

(51) Int. Cl. G06F 3/0484; G06T 1/20; G06F 3/0481; G06F 11/36; G06F 9/48

(52) U.S. Cl. CPC G06F 3/04847; G06T 1/20; G06F 9/4881; G06F 11/3664; G06F 3/0481

(57) ABSTRACT

Systems, methods, and computer readable media to visualize execution history with a shader debugger are described. Various implementations present a first graphical user interface (GUI) for navigating through an executed graphics frame and receive with the first GUI at least one user input that defines a region of interest. In response to receiving the user input, the shader debugger presents a second GUI that includes execution history of a first graphics processor thread associated with the region of interest. After receiving a second user input with the second GUI to switch to a second graphics processor thread associated with the region of interest, the shader debugger updates the second GUI with the execution history of the second graphics processor thread.

### BACKGROUND

This disclosure relates generally to the field of graphics processing. More particularly, but not by way of limitation, this disclosure relates to graphical user interfaces (GUIs) that visualize execution history for shaders and/or compute kernels that execute on a graphics processor, such as a graphics processing unit (GPU).

Computers, mobile devices, and other computing systems typically have at least one programmable processor, such as a central processing unit (CPU) and other programmable processors specialized for performing certain processes or functions (e.g., graphics processing). Examples of a programmable processor specialized to perform graphics processing operations include, but are not limited to, a GPU, a digital signal processor (DSP), a field programmable gate array (FPGA), and/or a CPU emulating a GPU. GPUs, in particular, comprise multiple execution cores (also referred to as graphics processor threads) designed to execute the same instruction on parallel data streams, making them more effective than general-purpose processors for operations that process large blocks of data in parallel. For instance, a CPU functions as a host and hands-off specialized parallel tasks to the GPUs. Specifically, a CPU can execute an application stored in system memory that includes graphics data associated with a video frame. Rather than processing the graphics data, the CPU forwards the graphics data to the GPU for processing; thereby, freeing the CPU to perform other tasks concurrently with the GPU's processing of the graphics data.

Certain characteristics of a GPU causes challenges for shader debuggers that sequential CPU debuggers do not account for. For instance, shader debuggers are tailored to handle the intrinsic parallelism of GPUs, which run a relatively large number (e.g., thousands or millions) of GPU threads in parallel when compared to a CPU. Typically, commands committed to the GPU for execution run through graphics pipelines, where at various locations in the pipeline, the commands generate events that a user may utilize to understand what occurs within the graphics pipeline. For instances, the events may allow a user to determine how often a GPU thread-based operation occurs. Being able to provide information relating to the execution of graphics source code is beneficial when testing and debugging shaders within the graphics pipelines.

### SUMMARY

In one implementation, a method is disclosed to present a graphical user interface (GUI) that comprises: a first window panel that presents execution history of a first graphics processor thread for a specified shader type and a second window panel that presents a first set of shader source code lines and a first set of variable values associated with the first set of shader source code lines. The first window panel includes a first set of function calls that represent function calls executed according to the execution history of the first graphics processor thread. The first set of shader source code lines correspond to the execution history of the first graphics processor thread. The example method receives a first user input associated with the second window panel indicative of a selection of a second graphics processor thread. Based on the first user input, the example method updates the first window panel by replacing the execution history of the first graphics processor thread with execution history of the second graphics processor thread, and updates the second window panel by replacing the first set of shader source code lines with a second set of shader source code lines.

In another implementation, a system comprises memory and a processor operable to interact with the memory. The processor is configured to receive, for a first GUI, a first user input that define a region of interest, where the region of interest includes a set of executed graphics tasks to debug. The second GUI comprises: a first window panel that presents execution history of a first graphics processor thread associated with the region of interest; and a second window panel that presents a first set of shader source code lines executed by the first graphics processor thread, a first set of variables, and variable values for the first set of variables. The processor is further configured to receive a second user input to switch to a second graphics processor thread associated with the region of interest and update, based on the second user input, the first window panel and the second window panel within the second GUI.

In yet another implementation, a method that presents a first GUI for navigating through an executed graphics frame. The example method receives with the GUI at least one user input that defines a region of interest, where the region of interest includes a set of executed graphics tasks to debug. In response to receiving the user input, the example method presents a second GUI that comprises: an execution history window panel that presents execution history of a first graphics processor thread associated with the region of interest; and a source code editor window panel that presents a first set of shader source code lines executed by the first graphics processor thread, a first set of variables associated with the first set of shader source code lines, and variable values for the first set of variables. The example method receives a second user input with the second GUI to switch to a second graphics processor thread associated with the region of interest and updates, based on the second user input, the execution history window panel by replacing the execution history of the first graphics processor thread with execution history of the second graphics processor thread. The example method also updates, based on the second user input, the source code editor window panel by replacing the first set of shader source code lines with a second set of shader source code lines.

In yet another implementation, a method that presents a first GUI for navigating through an executed graphics frame. The example method receives a first user input in an execution history window panel that transitions from a first execution history nodes in an execution history to a second execution history node in the execution history. Based on the first user input, a source code editor window panel updates presented variables values that corresponds to the second execution history node. The first execution history node and the second execution history node corresponds to a function call that is invoked multiple time with different parameters in a single graphics processor thread.

In one implementation, each of the above described methods, and variation thereof, may be implemented as a series of computer executable instructions. Such instructions may use any one or more convenient programming language. Such instructions may be collected into engines and/or programs and stored in any media that is readable and executable by a computer system or other programmable control device.

### BRIEF DESCRIPTION OF THE DRAWINGS

While certain implementations will be described in connection with the illustrative implementations shown herein, the disclosure is not limited to those implementations. On the contrary, all alternatives, modifications, and equivalents are included within the spirit and scope of the disclosure as defined by the claims. In the drawings, which are not to scale, the same reference numerals are used throughout the description and in the drawing figures for components and elements having the same structure, and primed reference numerals are used for components and elements having a similar function and construction to those components and elements having the same unprimed reference numerals.

FIG. 1A is a block diagram of a system where implementations of the present disclosure may operate.

FIG. 1B depicts debugging operations that a system may perform to visualize execution history within one or more GUIs.

FIG. 2 is illustrative a graphics frame that a graphics processing debugger may capture from a target application for shader debugging purposes.

FIG. 3 illustrates an implementation of an initial frame debugger GUI for defining a region of interest.

FIG. 4 illustrates an implementation of a shader GUI after defining a region of interest using the initial frame debugger GUI.

FIG. 5 illustrates another implementation of a shader GUI after defining a region of interest.

FIG. 6 illustrates another implementation of a shader GUI after defining a region of interest.

FIG. 7 illustrates another implementation of a shader GUI after defining a region of interest.

FIG. 8 depicts a flowchart illustrating a shader debugging operation that visualizes execution history for a defined region of interest.

FIG. 9 shows, in block diagram form, a system in accordance with one implementation.

FIG. 10, a simplified functional block diagram of illustrative device for the host component and/or device component.

### DETAILED DESCRIPTION

This disclosure includes various example implementations that generate GUIs for shader debugging. In one implementation, a debugger application includes a frontend debugger that generates a variety GUIs for different shader types (e.g., fragment shader or vertex shader). The frontend debugger allows a user to define a region of interest to trace and debug a set of executed graphics tasks (e.g., a set of vertices or a region of a frame buffer). Based on the user's selection, a GUI displays the execution history for one of the threads associated with the region of interest (e.g., a designated or preferred thread). For example, the debugger application displays execution history for a given graphics processor thread within a fragment shader GUI. The fragment shader GUI includes an execution history window panel and a source code editor window panel that includes source code executed by the given graphics processor thread. The source code editor window panel also includes variables and corresponding variable values for each node presented within the execution history window panel. In one or more implementations, the source code editor window panel also presents values and mask views that contain across-thread information for a given variable. The backend debugger supplies execution history to the frontend debugger to display for each GUI. As an example, the backend debugger processes a trace buffer associated with the execution of an instrumented shader to supply to the frontend debugger execution history data for each graphics processor thread.

In the following description, for purposes of explanation, numerous specific details are set forth in order to provide a thorough understanding of the inventive concept. As part of this description, some of this disclosure's drawings represent structures and devices in block diagram form in order to avoid obscuring the disclosure. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one implementation” or to “an implementation” means that a particular feature, structure, or characteristic described in connection with the implementation is included in at least one implementation of the disclosure, and multiple references to “one implementation” or “an implementation” should not be understood as necessarily all referring to the same implementation.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

The disclosure also uses the term “compute kernel,” which has a different meaning and should not be confused with the term “kernel” or “operating system kernel.” In particular, the term “compute kernel” refers to a program for a graphics processor (e.g., GPU, DSP, or FPGA). In the context of graphics processing operations, programs for a graphics processor are classified as a “compute kernel” or a “shader.” The term “compute kernel” refers to a program for a graphics processor that performs general compute operations (e.g., compute commands). The term “shader” refers to a program for a graphics processor that define and/or perform graphics operations (e.g., render commands). Illustrative types of “shaders” include vertex, geometry, tessellation (hull and domain) and fragment (or pixel) shaders. The term “shader” is synonymous and can also be referenced as “shader program” within this disclosure.

For clarification purposes, the term “kernel” refers to a computer program that is part of a core layer of an operating system (e.g., Mac OSX™) typically associated with relatively higher or the highest security level. The “kernel” is able to perform certain tasks, such as managing hardware interaction (e.g., the use of hardware drivers) and handling interrupts for the operating system. To prevent application programs or other processes within a user space from interfering with the “kernel,” the code for the “kernel” is typically loaded into a separate and protected area of memory. Within this context, the term “kernel” may also be referenced as “operating system kernel.”

As used herein, the term “application program interface (API) call” in this disclosure refers to an operation an application is able to employ using a graphics application program interface (API). Examples of API calls include draw calls for graphics operations and dispatch calls for computing operations. Examples of graphics API include OpenGL®, Direct3D®, or Metal® (OPENGL is a registered trademark of Silicon Graphics, Inc.; DIRECT3D is a registered trademark of Microsoft Corporation; and METAL is a registered trademark of Apple Inc.). Generally, a graphics driver translates API calls into commands a graphics processor is able to execute. The term “command” in this disclosure refers to a command encoded within a data structure, such as command buffer or command list. The term “command” can refer to a “render command” (e.g., for draw calls) and/or a “compute command” (e.g., for dispatch calls) that a graphics processor is able to execute.

As used herein, the term “region of interest” in this disclosure refers to a set of executed graphics tasks to debug. Examples of graphics tasks include a set of vertices for a vertex shader or a region of a frame buffer for a fragment shader. In one implementation a region of interest can correspond to sub-region of a graphics frame while in other implementations the region of interest can correspond to the entire graphics frame. The term “execution history” in this disclosure refers to executed source code by one or more graphics processor threads. The executed source code corresponds to source code for shaders or compute kernels. In one or more implementations, execution history can be arranged in order of execution and grouped by function calls, loops, and/or iterations.

For the purposes of this disclosure, the term “processor” refers to a programmable hardware device that is able to process data from one or more data sources, such as memory. One type of “processor” is a general-purpose processor (e.g., a CPU) that is not customized to perform specific operations (e.g., processes, calculations, functions, or tasks), and instead is built to perform general compute operations. Other types of “processors” are specialized processor customized to perform specific operations (e.g., processes, calculations, functions, or tasks). Non-limiting examples of specialized processors include GPUs, floating-point processing units (FPUs), DSPs, FPGAs, application-specific integrated circuits (ASICs), and embedded processors (e.g., universal serial bus (USB) controllers).

As used herein, the term “graphics processor” refers to a specialized processor for performing graphics processing operations. Examples of “graphics processors” include, but are not limited to, a GPU, DSPs, FPGAs, and/or a CPU emulating a GPU. In one or more implementations, graphics processors are also able to perform non-specialized operations that a general-purpose processor is able to perform. As previously presented, examples of these general compute operations are compute commands associated with compute kernels.

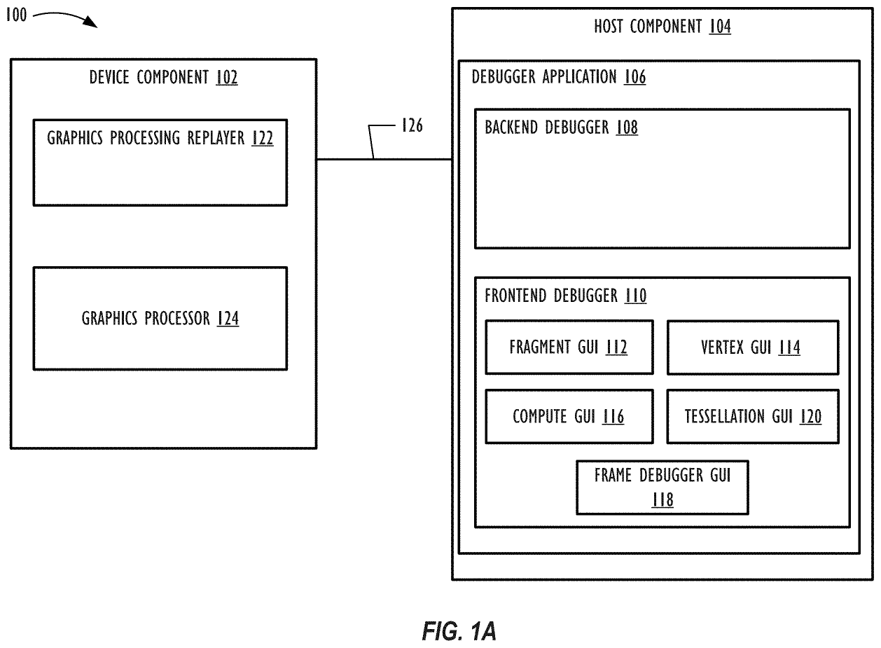

FIG. 1A is a block diagram of a system 100 where implementations of the present disclosure may operate. In FIG. 1A, system 100 includes a device component 102 and a host component 104. Host component 104 may, for example, be a server, workstation, desktop, laptop, notebook and/or any other computing system that runs debugger application 106. Device component 102 could, for example, be a mobile telephone, a portable entertainment device, a desktop, a laptop, a notebook, a pad computer system, a digital media player, and/or other computing system that generates a graphics frame from a target application that debugger application 106 is setup to debug. The debugger application 106 is a single application, program, or program module or embodied in a number of separate program modules.

FIG. 1A illustrates that the device component 102 and the host component 104 are coupled together via a communication link 126. The communication link 126 may represent a direct or an indirect connection between device component 102 and host component 104. For example, communication link 126 directly connects device component 102 and host component 104 via a physical connection (e.g., wired connection) or wireless connection (e.g., Bluetooth® connection (Bluetooth is a registered trademark owned by Bluetooth Sig, Inc.)). Alternatively, communication link 126 may be or part of a network that includes a local area network (LAN), the Internet, an enterprise network, and/or other networks that indirectly couple device component 102 and host component 104.

In FIG. 1A, the device component 102 includes a graphics processing replayer 122 that is able to replay a graphics frame previously captured by a graphics processor capture application (not shown in FIG. 1A). The graphics processor capture application typically runs alongside a target application capturing the graphics API commands and resources for a graphics frame. The graphics processing replayer 122 represents a single application, program, or program module or embodied in a number of separate program modules that run on device component 102 and replays the captured graphics frame. In the context of a shader debugger, the graphics processing replayer 122 instructs the graphics processor 124 to execute an instrumented shader or compute kernel and log execution information within one or more trace buffers. The graphics processing replayer 122 obtains the trace buffer with execution information from the graphics processor 124 and provides the execution information stored in the trace buffer to the debugger application 106. To execute the instrumented shader or compute kernel, the graphics processor 124 may utilize one or more graphics processor threads and other computing logic for performing graphics and/or general compute operations in a parallel manner. Stated another way, the graphics processor 124 may also encompass and/or communicate with memory (e.g., memory cache), and/or other hardware resources to execute the instrumented shaders or compute kernels. For example, graphics processor 124 is able to process instrumented shaders with rendering pipelines and instrumented compute kernels with compute pipelines.

As shown in FIG. 1A, the host component 104 includes a debugger application 106 that contains a backend debugger 108. The backend debugger 108 acts as an underlying layer of the debugger application 106 that controls and manages different debugging operations. By way of example, the backend debugger 108 is able to control shader and compute kernel instrumentation, communicate with the graphics processing replayer 122 to execute the instrumented shader or compute kernel and obtain execution information within trace buffers, and process contents within the trace buffers. By processing contents within the trace buffers, the backend debugger 108 sorts and determines the execution history for each graphics processor thread that processed the instrumented shader or compute kernel, variables within the instrumented shader or compute kernel, and data to generate value and mask views for any of the variables. In one or more implementations, the backend debugger 108 may also perform processing operations to link graphics API resources (e.g., buffer pointers, textures, samplers) within a shader to associated graphics API objects (e.g., graphics API level and CPU accessible resources, such as buffers, textures, samplers).

The host component 104 also includes a frontend debugger 110 that communicates with the backend debugger 108. In one or more implementations, the host component 104 includes a set of communication protocols that allow the backend debugger 108 and the frontend debugger 110 to communicate and exchange information with each other. The frontend debugger 110 utilizes the communication protocols to generate and send query requests to the backend debugger 108 to debug a region of interest, for example a particular shader stage in a specific draw/dispatch call. As an example, one of the communication protocols can be set to create a shader debugger data source for a given a region of interest (e.g., a given draw call and shader type). Once the backend debugger 108 processes execution information stored within a trace buffer, the frontend debugger 110 is able to receive shader debugger data source objects to further query the backend debugger 108. When querying the backend debugger 108, the frontend debugger 110 could use a DataSource protocol that allows the frontend debugger 110 to query for session debugger information, such as executed graphics processor threads, variables for a particular execution history node, value and/or mask texture information. Another protocol, ShaderDebuggerThread protocol, could define a set of properties for the frontend debugger 110 to query graphics processor thread information, such as execution history for a thread and thread properties (e.g., instance/vertex identifiers for vertex shaders or position/sample identifiers for fragment shaders), from backend debugger 108. Other debugger protocols can allow the frontend debugger 110 to query execution history information (e.g., node information) and variable information from the backend debugger 108.

After receiving querying response from the backend debugger 108, the frontend debugger 110 may utilize the execution history obtained from the backend debugger 108 to present and display shader debugger data within one or more GUIs. Using FIG. 1A as an example, the frontend debugger 110 is able to display execution history within a fragment GUI 112, a vertex GUI 114, and/or a tessellation GUI 120 for an instrumented shader. The frontend debugger 110 can also include a compute GUI 116 for displaying execution history for an instrumented compute kernel.

FIG. 1B depicts debugging operations that system 100 may perform to display execution history within one or more GUIs. At operation 132, a user is able to utilize the frontend debugger 110 to define a region of interest. For example, the frontend debugger 110 includes an initial frame debugger GUI 118 configured with menu options that enable a user to define the region interest by providing one or more user inputs. As an example, a user is able to select a specific a draw call and a specific shader type associated with the draw call to define the region of interest. By doing so, the region of interest defines not only the graphics processor thread that the user selects to be traced and debugged within the debugger application 106, but also includes a set of graphics processor threads that surround the selected thread. Examples of shader types include vertex shaders (e.g., primitives), fragment shaders (e.g., pixels), and tessellation shaders (e.g., patches). For dispatch calls, the frontend debugger 110 defines a region of interest for a compute kernel (e.g., threadgroup) also using the initial frame debugger GUI 118. After a user defines the region of interest with the initial frame debugger GUI 118, the frontend debugger 110 sends a request to the backend debugger 108 to generate a shader debugger session for the defined region of interest.

Once the backend debugger 108 receives the request, the backend debugger 108 performs operation 134 to start the shader debugger session and send shader debugger session information to the graphics processing replayer 122. The shader debugger session information provides to the graphics processing replayer 122 the region of interest that the frontend debugger 110 previously defined. The backend debugger 108 also utilizes a graphics API frontend compiler (not shown in FIG. 1B) to insert instrumentation code within code lines of the selected shader or compute kernel obtained from the frontend debugger 110. The instrumentation code contains instructions to buffer and store logged execution information, such as values of variable addresses and executed variable values, to one or more trace buffers. In other words, the graphics API frontend compiler instruments a shader or compute kernel to define how and what information is dumped into the trace buffers. In one or more implementations, the backend debugger 108 uses a host-side and/or offline graphics API compiler to instrument the shader or compute kernel into a precompiled graphics library to achieve better runtime performance. After the graphics processing replayer 122 receives the shader debugger session information and instrumentation code, the graphics processing replayer 122 replays the frame until reaching the selected draw call or dispatch determined from the region of interest. The graphics processing replayer 122 also creates the trace buffer that stores the logged execution information.

In FIG. 1B, the graphics processing replayer 122 then performs operation 136 and commits the instrumented shader for runtime execution. The graphics processor 124 executes the received instrumented shader and logs execution information within the trace buffer based on the instrumentation code. At operation 138, the graphics processor 124 completes execution of the instrumented shader, and the graphics processing replayer 122 reads back execution information stored in the trace buffer. At operation 140, the graphics processing replayer 122 sends the trace buffer to the backend debugger 108 along with any additional information to process the trace buffer. For example, the graphics processing replayer 122 could provide a metadata file that contains metadata information associated with the instrumented shader. Examples of metadata information include variable information (e.g., variable name, type, and address space) and function information, (e.g., function name, parameters, and return types).

At operation 142, the backend debugger 108 processes the trace buffer and metadata file to generate one or more backend data structures. In one or more implementations, the backend debugger 108 separates out the trace buffer into backend data structures to obtain per-thread execution history. In particular, the backend debugger 108 configures one or more backend data structures to include the execution history for one or more graphics processor threads in the region of interest. For example, each backend data structures store execution history of a single graphics processor thread in the defined region interest. In particular, the backend data structures could include execution history information, such as execution history nodes (e.g., function calls, loop and loop iterations), variables and variable values, and graphic processor thread information. The backend debugger 108 provides the execution history stored in the backend data structures via the communication protocols to the frontend debugger 110 to display within one or more of the GUIs 112, 114, 116, and 120.

From this point on, operation 146 represents one or more operations that display execution history for the defined region of interest within a GUI of the frontend debugger 110. In FIG. 1B, the GUIs include fragment GUI 112, vertex GUI 114, computer GUI 116, and tessellation GUI 120. The frontend debugger 110 is able to send requests to the backend debugger 108 to obtain a subset of data associated with the execution history of the instrumented shader or compute kernel. For example, the frontend debugger 110 could request data for a given region of interest that corresponds to: (1) variables that are modified within a particular execution history node, (2) variable values at any given point of the execution history, (3) value and thread mask data to present views within the source code that contain across-thread information, and (4) graphics API resources to present within the graphics GUIs (e.g., fragment GUI 112 or vertex GUI 114).

Although FIGS. 1A and 1B illustrates specific implementations of system 100 that displays shader debugger information, the disclosure is not limited to these particular implementations. For instance, with reference to FIGS. 1A and 1B, the disclosure describes specific operations that the graphics processing replayer 122 and backend debugger 108 perform to capture and obtain execution history for a shader and/or computer kernel. As an example, recall that system 100 is able to use a graphics API frontend compiler to instrument a shader or compute kernel to define how and what information is dumped into a trace buffer. However, other implementations of system 100 could utilize different operations to capture and obtain execution history for the shader and/or computer kernel. Stated another way, the frontend debugger 110 operates separate and independent from the backend debugger 108 and graphics processing replayer 122. Because of the independent operation, the frontend debugger 110 is able to generate GUIs 112, 114, 116, and 120 as long as the frontend debugger 110 is able to obtain per-thread execution history information. Additionally, the frontend debugger 110 is not limited to generating GUIs 112, 114, 116, and 120, and is able to generate other GUIs not shown in FIGS. 1A and 1B. The use and discussion of FIGS. 1A and 1B are only examples to facilitate ease of description and explanation.

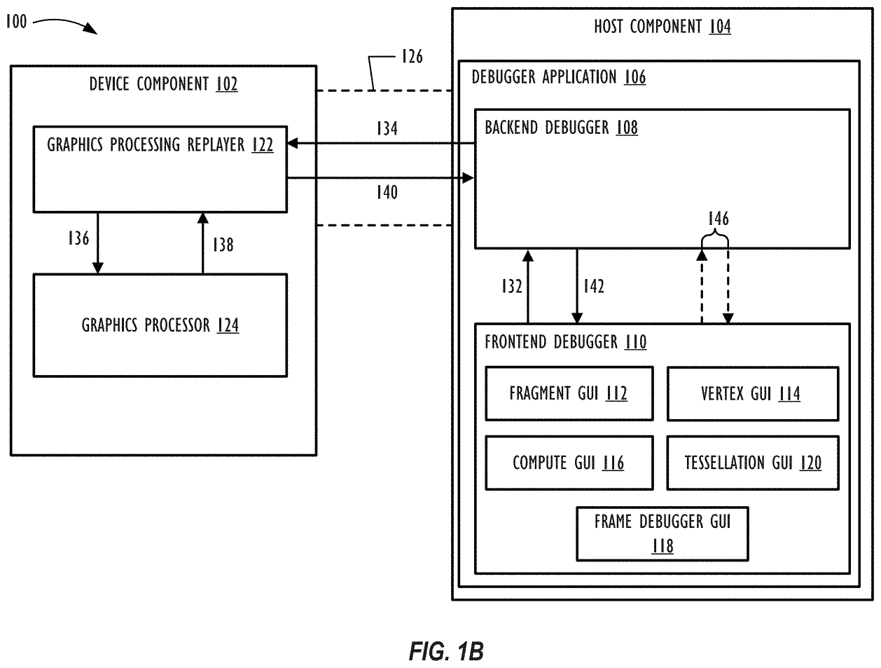

FIG. 2 is illustrative a graphics frame 200 that a graphics processing debugger may capture from a target application for shader debugging purposes. Referring to FIG. 1B as an example, graphics processing replayer 122 replays graphics frame 200 that includes instructions that can be divided into one or more render phases 205. Each of the render phases 205 can have one or more draw calls 210, where each draw call 210 contains one or more shaders 215. Graphics processor 124 is able to execute each shader 215 using one or more graphics processor threads. In FIG. 2, graphics frame 200 comprises a sequence of R render phases 205, D draw calls 210, and S shaders 215, where each draw call includes a number of shaders 215. As an example, one or more draw calls 210 contain two shaders 215: a vertex shader followed by a fragment shader. Other implementations of graphics frame 200 have one or more draw calls 210 that contain more than or less than two shaders 215.

Using FIG. 2 as an example, shader S 215 can represent a shader that a user has defined as a region of interest. With reference to FIG. 1B, a graphics processing replayer 122 can replay graphics frame 200 until reaching draw call D 210 based on the defined region of interest. A graphics API frontend compiler may instrument shader S 215 that graphics processor 124 eventually executes. The graphics processor 124 utilizes multiple graphics processor threads to execute instrument shader S 215 in a parallel manner. The execution of instrument shader S 215 is logged into a trace buffer. After graphics processor 124 finishes executing instrumented shader S 215, the backend debugger 108 provides the frontend debugger 110 with the execution history of shader S 215. The frontend debugger 110 then uses a GUI to display a per-thread execution history for shader S 215. As an example, if shader S 215 is a fragment shader then frontend debugger 110 would use fragment GUI 112 to display the per-thread execution history. The fragment GUI 112 can also present variables and associated variable values modified during shader execution and value and thread mask views that contain across-thread information.

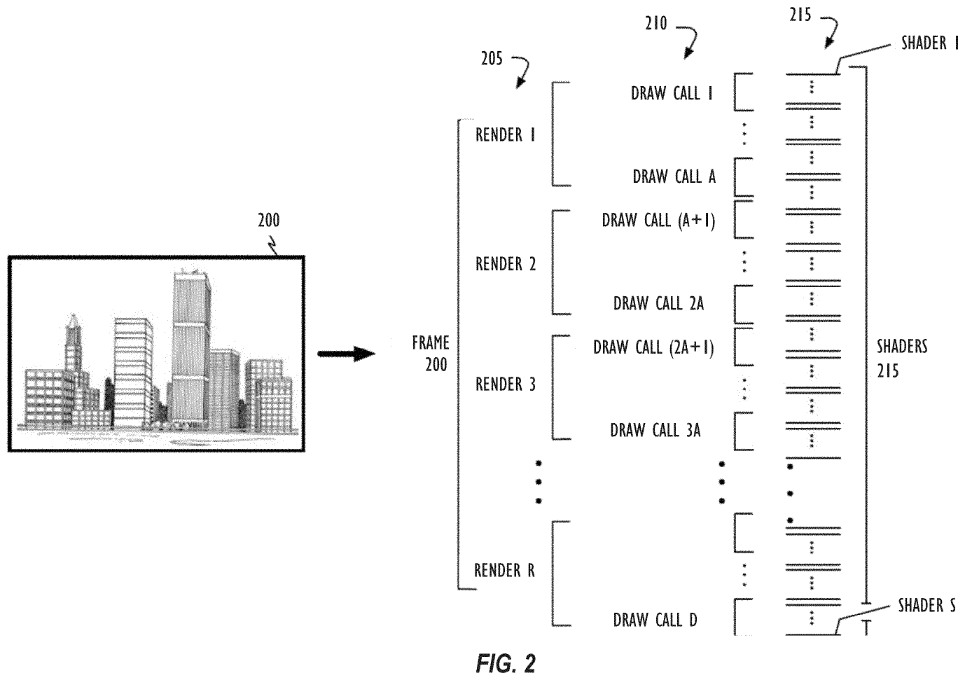

FIG. 3 illustrates an implementation of an initial frame debugger GUI 300 for defining a region of interest. Recall that a frontend debugger is able to generate multiple GUIs, one of which is the initial frame debugger GUI 300 that a user utilizes to select a region of interest. FIG. 3 illustrates that the initial frame debugger GUI 300 is a window, where at least a portion of the window includes a frame navigator window panel 302 that allows a user to navigate through a graphics frame (e.g., graphics frame 200 shown in FIG. 2). The frame navigator window panel 302 presents a plurality of render command encoders, where each render command encoder corresponds to a render phase 205 depicted in FIG. 2. Each render command encoder is positioned next to an indicator 332 (e.g., triangle symbol) that permits a user to expand or collapse render command encoders based on a user input (e.g., clicking a mouse or tapping a screen). In FIG. 3, a user has set the indicators 332 for render command encoder A, C, D, and E to a collapsed state. A collapse state causes subcategories (e.g., draw calls) associated with the render command encoder A, C, D, and E to be hidden and not presented to a user within the frame navigator window panel 302.

In contrast, a user has set indicators 332 for render command encoder B to an expanded state. Because of the expanded state, the frame navigator window panel 302 presents the set of draw calls encoded by the render command encoder B. The draw calls shown within the frame navigator window panel 302 corresponds to the draw calls 210 shown in FIG. 2 and represent subcategories for the render command encoder B. The draw calls within the frame navigator window panel 302 are also adjacent to an indicator 332 (e.g., triangle symbol) that allows a user to expand or collapse draw calls. FIG. 3 depicts that indicators 332 for all draw calls are in a collapsed state. Other implementations of the initial frame debugger GUI 300 could have one or more of the indicator 332 for the draw calls in an expanded state to present subcategories for the draw calls. For example, an expanded draw call could present a set of shaders that correspond to shaders 215 shown in FIG. 2.

As shown in FIG. 3, based on one or more user inputs, a user selects draw call G within render command encoder B. Examples of possible user inputs include, but are not limited to, a left-click with a mouse, double click with a mouse, click and hold with a mouse, tap using a single finger on a touch screen, tap and hold on a touch screen, and/or double tapping using a finger and/or touch point device. When the user selects a draw call, the frame navigator window panel 302 presents a highlight box 318 to indicate the user's selection. FIG. 3 illustrates that the initial frame debugger GUI 300 also contains a shader navigator window panel 304 that presents shaders and graphics API resources for the selected draw call (e.g., draw call G). Both shader types (e.g., vertex shader and fragment shader) within shader navigator window panel 304 have been expanded to display the graphics API resources. Using FIG. 3 as an example, the vertex shader includes buffers A-C and fragment shader includes textures A-C. Buffers A-C are positioned adjacent to buffer icons 320 and textures A-C are positioned adjacent to texture icons 322.

In one or more implementations, a user is able to define a region of interest with the initial frame debugger GUI 300 by utilizing the frame preview window panel 306. The frame preview window panel 306 generates a preview of the frame buffer to be rendered. In FIG. 3, once a user selects draw call G within the frame navigator window panel 302, the frame preview window panel 306 highlights the relevant portion within the previewed frame that corresponds to draw call G. A user may provide one or more user inputs (a left click on a mouse) to select the portion of the previewed frame that correspond to draw call G. After selecting the portion of the previewed frame, a user may provide one or more user inputs (e.g., a right click on a mouse) to generate a menu sub-window 326 that presents debug option 330 (e.g., debug focus pixel option) and/or other menu options 328 (e.g., menu options B and C 328). By selecting the debug option 330 the user selects the shader type for the region of interest. The region of interest is defined by the region surrounding the pixel that the user selects when providing user inputs to obtain debug option 330. Afterwards, the frontend debugger transitions the initial frame debugger GUI 300 into another GUI, for example, a fragment GUI, vertex GUI, or a tessellation GUI. Other implementations of the initial frame debugger GUI 300 are able to define the region of interest using other combinations of GUI instructions and/or menu options.

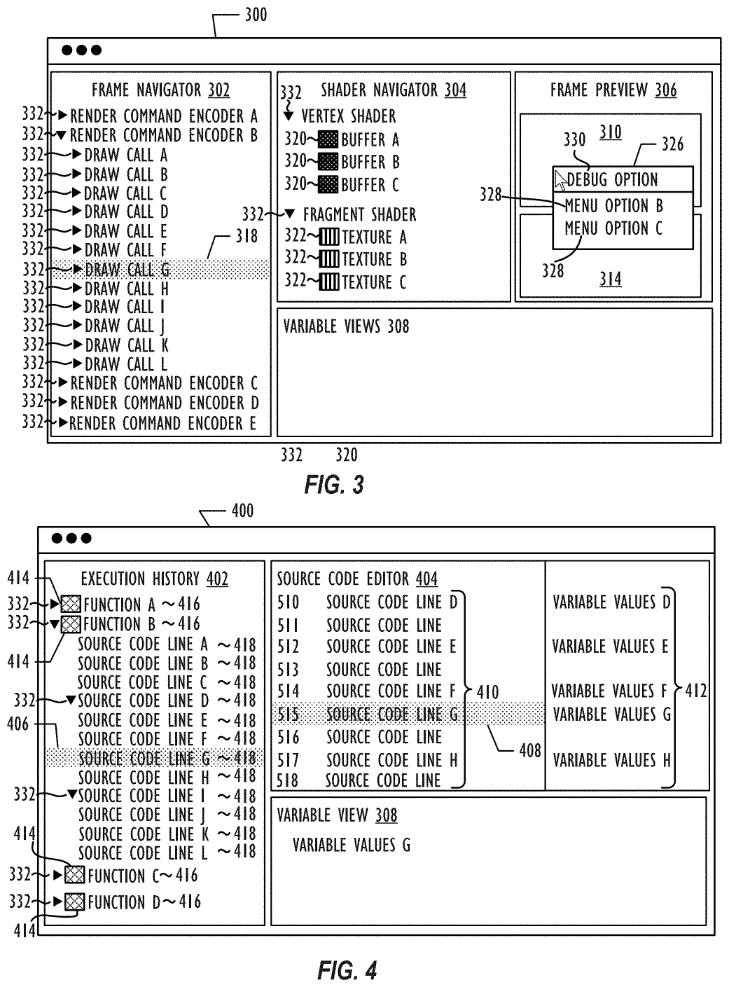

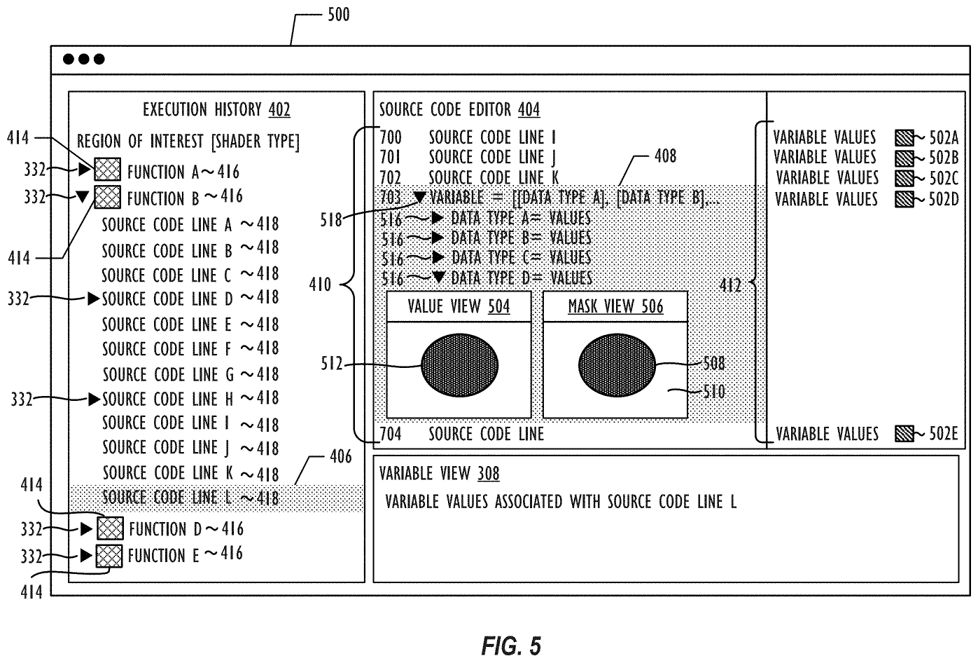

FIG. 3 illustrates that initial frame debugger GUI 300 can also contain a variable view window panel 308. The variable view window panel 308 presents variables and variable values that corresponds and/or are in scope with the currently selected execution history node. Although not specifically shown in FIG. 3, the variable view window panel 308 could include control menus and/or other debugging control options (e.g., debug bar) for debugging purposes. The variable view window panel 308 is discussed in more detail in FIGS. 4 and 5.

FIG. 4 illustrates an implementation of a shader GUI 400 after defining a region of interest using the initial frame debugger GUI. With reference to FIG. 1B, the shader GUI 400 could correspond to the fragment GUI 112, vertex GUI 114, or tessellation GUI 120. The shader GUI 400 may be a window that includes an execution history window panel 402 to present execution history for a graphics processor thread associated with the defined region of interest. In one or more implementations, the execution history window panel 402 presents a per-thread execution history for a specific shader type (e.g., a fragment shader). In FIG. 4, the execution history window panel 402 also arranges the execution history nodes, such as function call nodes 416 and source code line nodes 418, in order of execution.

As shown in FIG. 4, the execution history window panel 402 includes execution history nodes, such as function call nodes 416 and source code line nodes 418. Each execution history node can represent a function call, source code line, loop or loop iteration executed by a graphics processor. In FIG. 4, each function call node 416 and some of the source code line nodes 418 (e.g., source code line D node 418) can be expanded or collapsed by adjusting indicator 332. The function call nodes 416 represent function calls that include a corresponding function icon 414 and source code line nodes 418 correspond to source code lines for a shader. Other implementations of execution history window panel 402 could also include other types of execution history nodes, such as nodes representing loops, loop iterations, and a final source code line node.

Each function call node 416 represents a function call within the shader that includes one or more executed source codes lines. In FIG. 4, a user expands function call B node 416 to present executed source code line A-L nodes 418. FIG. 4 depicts that function call A node 416 is at a first hierarchical level and is still in a collapsed state. Execution history window panel 402 classifies function call A node 416 and function call B node 416 at the same hierarchical level (e.g., first hierarchical level). Because executed source code line A-L nodes 418 are sub-categories of function call B node 416, the execution history window panel 402 has the executed source code line A-L nodes 418 at a hierarchical level (e.g., a second hierarchical level) under function call A and B nodes 416. In another implementation of shader GUI 400, the execution history window panel 402 could have single function call node 416 at the first hierarchical level that represents an entry point function. No other execution history nodes would be located at the same hierarchical level as the single function call node 416. When expanding the single function call node 416, the execution history window panel 402 presents other execution history nodes, such as lower hierarchical level function call nodes 416 and/or source code line nodes 418.

By having function call nodes 416 configured to expand or collapse, a user is able to step-in, step-out, and/or step-over function calls presented within execution history window panel 402. As an example, a user is able to step into function call B node 416 by expanding function call B node 416 and providing one or more user inputs (e.g., up and down keyboard arrows) to step through one or more sub-categories (e.g., executed source code line A-L nodes 418) within function call B node 416. Once a user steps into function call B node 416, a user can then step out of function call B node 416 by providing user inputs that causes highlight box 406 to move from highlighting a sub-category in function call B node 416 to highlighting a different function call node 416 outside of function call B node 416 (e.g., function call A node 416). A user can complete a step-over of function call nodes 416 when a function call node 416 is in a collapsed state. For example, a user can collapse function call B node 416, and after collapsing the function call B node 416, move the highlight box 406 from function call B node 416 to function call A node 416 or down to another function call node 416 (e.g., function call E node 416 not shown in FIG. 4.). By doing so, the user does not step-into function call B node 416, but rather steps over function call B node 416 to another function call node 416.

In one implementation, a user may set breakpoints that interrupt execution of the shader in order to locate problems within the source code. Stated another way, the shader does not complete its execution, and instead when a shader encounters a breakpoint, the shader debugger pauses the shader and populates variable values within the variable view window panel 308. Because of the breakpoints, a user is able to manually step through and examine step-by-step variable information at lines of source code to assess how variable state and values change during execution. A user can subsequently disable and delete breakpoints after completing shader debugging operation to allow the shader to complete execution. In instances where execution history is unavailable for a region of interest, user may be unable to view certain variable values and states once the entire shader completes execution.

Recall that frontend debugger is able to generate the execution history presented within execution history window panel 402 after the entire shader finishes execution on a graphics processor. Rather than utilizing breakpoints that interrupt execution of a shader, the shader GUI 400 generates within the source code editor window panel 404 variable values 412 for each line of source code 410 that executes. The source code editor window panel 404 presents numerical text to indicate the line numbers for source code 410. For example, FIG. 4 depicts that highlight box 406 highlights source code line G node 418 within execution history window panel 402. The source code editor window panel 404 presents the text “515” to indicate to a user that the line of source code 410 highlighted with highlight box 408 corresponds to line “515.” FIG. 4 also depicts that the source code editor window panel 404 presents the text “510”-“514” and “516”-“518” to indicate other lines of source code 410.

Within the source code editor window panel 404, each executed line of source code 410 has variable values 412. The variable values 412 represent the values stored for variables after the graphics processor executes each line of source code 410. In one or more implementations, the variable values 412 presented within the source code editor window panel 404 are obtained from the backend debugger that processes trace buffers for an instrumented shader. FIG. 4 also illustrates that variable view window panel 308 shows the variables that are modified and/or in scope for the currently selected source code line G node 418.

At least a portion of the shader GUI 400 updates when a user selects a different graphics processor thread to view within the region of interest. In particular, information within the execution history window panel 402 and source code editor window panel 404 are updated when a user selects a different graphics processor thread to view via one or more user inputs. As an example, when a user selects a different graphics processor thread to view, execution history window panel 402 may present different function call nodes 416, source code line nodes 418 within one or more function call nodes 416, and/or other execution history nodes (e.g., loop and iteration nodes). The source code editor window panel 404 would also update the different variable values 412 for each previously executed lines of source code 410, and the variable view window panel 308 may also update depending on the selected source code line node 418. Being able to view shader execution history for different graphics processor threads may be beneficial because of the numerous number of graphics processor threads a graphics processor may utilize to execute a shader. An example of alternating between graphics processor threads based on user inputs is discussed in more detail in FIG. 5.

FIG. 5 illustrates another implementation of a shader GUI 500 after defining a region of interest for a shader. Using FIG. 1B as an example, the shader GUI 500 corresponds to the fragment GUI 112. FIG. 5 is similar to the shader GUI 400 shown in FIG. 4, except that shader GUI 500 contains source code icons 502A-502E that provide an option for user to expand and collapse corresponding lines in source code 410. In FIG. 5, activating source code icons 502A, 502B, 502C, 502D, and 502E using one or more user inputs allows a user to expand or collapse lines shown within the shader GUI 500. The source coded editor 404 presents text “700,” “701,” “702,” “703,” and “704,” to indicate the different lines of source code 410. For example, when a user input activates source code icon 502D, highlight box 408 indicates that a user has selected a specific line of source code 410. Based on the activation of the source code icon 502D, a source code indicator 518 appears at line “703” of source code 410 that allows a user to expand or collapse line “703” of source code 410. FIG. 5 shows that source code indicator 518 has been set to an expanded state and shows the values of data types A-D. Recall that each line of the source code 410 can define variables or graphics API resources. The data types A-D represent values for variables or graphics API resources found within lines of source code 410. FIG. 5 also illustrates that a source code indicator 516 appears next to each of the data types A-D at line “703” of the source code 410 to allow a user to be able to observe additional information for variables and/or graphics API resources within the source code editor window panel 404.

Referring to FIG. 5, the source code indicator 516 for data type D is in an expanded state and the other source code indicators 516 for data type A-C are in a collapsed state. For data type D, the shader GUI 500 generates textures views that provides across-thread information for the variable in line “703.” Specifically, the mask view 506 represents a texture view that presents which graphics processor threads have executed line “703.” In FIG. 5, executed graphics processor threads 508 refer to threads within the defined region of interest that have executed the same prior source code lines and also executed line “703” of source code 410. Unexecuted graphics processor threads 510 represents threads within the defined region of interest that did not execute line “703” of source code 410. The value view 504 represents a texture view that presents the executed thread values 512 for executed graphics processor threads 508 shown in the mask view 506. Source code editor window panel 404 could generate value view 504 and mask view 506 for one or more nested elements of a variable within an execute line of source code 410. As an example, the nested elements of the variable can be a struct, such as “s {float3 a; float3 b},” where source code editor window panel 404 generates a value view 504 and a mask view 506 for each of the nested elements a and b.

In one or more implementations, the user is able to provide one or more user inputs (e.g., mouse click on the mask view 506) that selects a new, graphics processor thread and updates the shader GUI 500 with execution history information for the selected thread. As an example, as user may select a new, graphics processor thread within the value view 504 or mask view 506. When a user selects the new graphics processor thread, the function call nodes 416, source code line nodes 418, and/or other execution history nodes shown in the execution history window panel 402 updates with information that corresponds to the newly, selected graphics processor thread. The source code editor window panel 404 also updates the source code 410 and variable values 412, and variable view panel 308 updates variables and variable values shown the different panels. Other implementations of shader GUI 500 could have other menu options to switch between thread views for a defined region of interest.

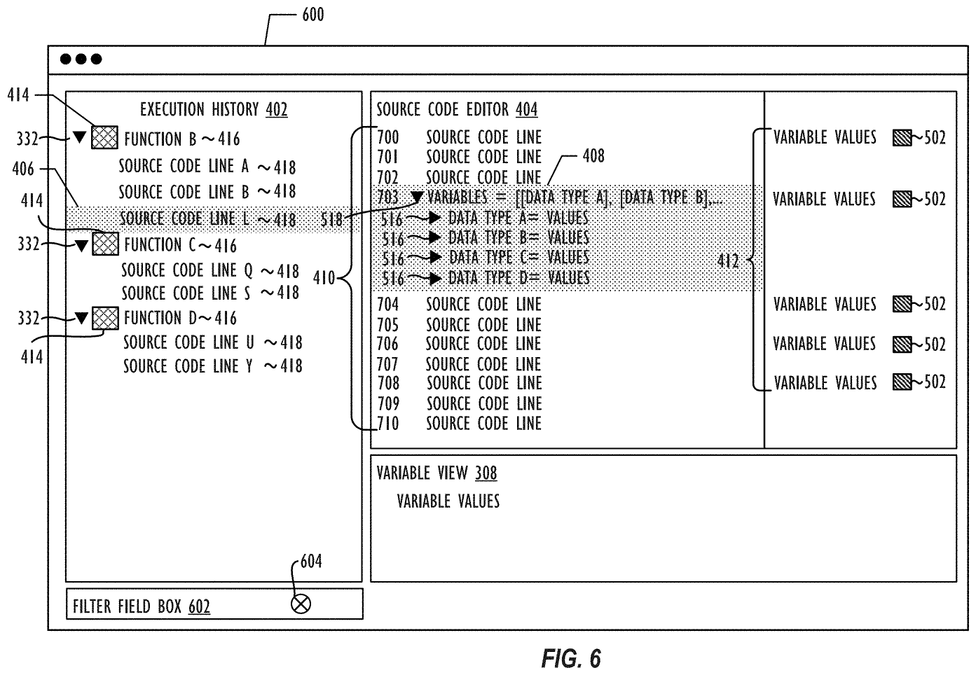

FIG. 6 illustrates another implementation of a shader GUI 600 after defining a region of interest for a shader. Referring back to FIG. 1B, the shader GUI 600 corresponds to the fragment GUI 112, vertex GUI 114, and/or tessellation GUI 120. Shader GUI 600 is similar to shader GUI 500 except that shader GUI 600 includes a filter field box 602. The filter field box 602 allows a user to input a filter string to filter execution history nodes by variables and functions. As an example, the entered filtered string within filter field box 602 causes the execution history window panel 402 to filter out execution history nodes that have modified variables and/or resource that do not match the filter string and functions that were called and executed. The filter field box 602 also allows a user to filter out execution history nodes using string-based matching with the contents of the source code line. For example, a given line of source code could include the express “int b=4; /* this is a comment */.” If the filter string is “comment,” then the execution history window panel 402 filters out the execution history node associated with the given line of source code.

Once a user enters the filter string, the execution history window panel 402 is updated with execution history nodes executed by the graphics processor thread that do not include the filter string and filters out execution history nodes that match the filter string. With reference to FIG. 5, after the user enters the filter string in the filter field box 602, FIG. 6 illustrates that function call A node 416, source code line nodes C-K 418 have been filtered out and no longer are presented within the execution history window panel 402. At this point, the execution history window panel 402 has been updated to present source code line A, B, L, Q, S, U, and Y nodes 418 since the variables include the search string entered into the filter field box 602. Other implementations of the filter field box 602 could be configured to filter out execution history nodes that do not match the entered filter string rather than execution history nodes that match the entered filter string. The filtered results that the execution history window panel 402 presents may vary from thread to thread in a defined region of interest. As previously discussed, the backend debugger provides the frontend debugger per-thread execution history for a defined region of interest, and the execution history window panel 402 presents the execution history for a specific graphics processor thread. In instances where a user selects a new, graphics processor thread within the defined region of interest, the filter results shown in execution history window panel 402 may also be updated based on the selection of the new, graphics processor thread. As an example, the newly, selected graphics processor thread may not have executed source code line L node 418 within function call B node 416. As a result, source code line L node 418 within function call B node 416 may not be presented within the execution history window panel 402. Additionally or alternatively, the filtered results may include other source code line nodes 418 not shown in FIG. 6 since the newly, selected graphics processor thread could have executed source code line nodes that the previously selected graphics processor thread did not execute.

In FIG. 6, a user is able to remove the filter settings by activating the cancel icon 604 within the filter field box 602. For example, a user may select provide a user input (e.g., mouse click) on the cancel icon 604 that deletes the search string entered within the filter field box 602. Without an entered search string, the execution history window panel 402 may be updated with all function call nodes 416, source code line nodes 418, and/or other execution history nodes that executed for a specific shader. Using FIGS. 5 and 6 as an example, when a user activates the cancel icon 604, the execution history window panel 402 changes from filtered execution history shown in FIG. 6 back to the un-filtered execution history depicted in FIG. 5. Other embodiments of shader GUI 600 could utilize other GUI instructions and/or menu options to remove filter settings.

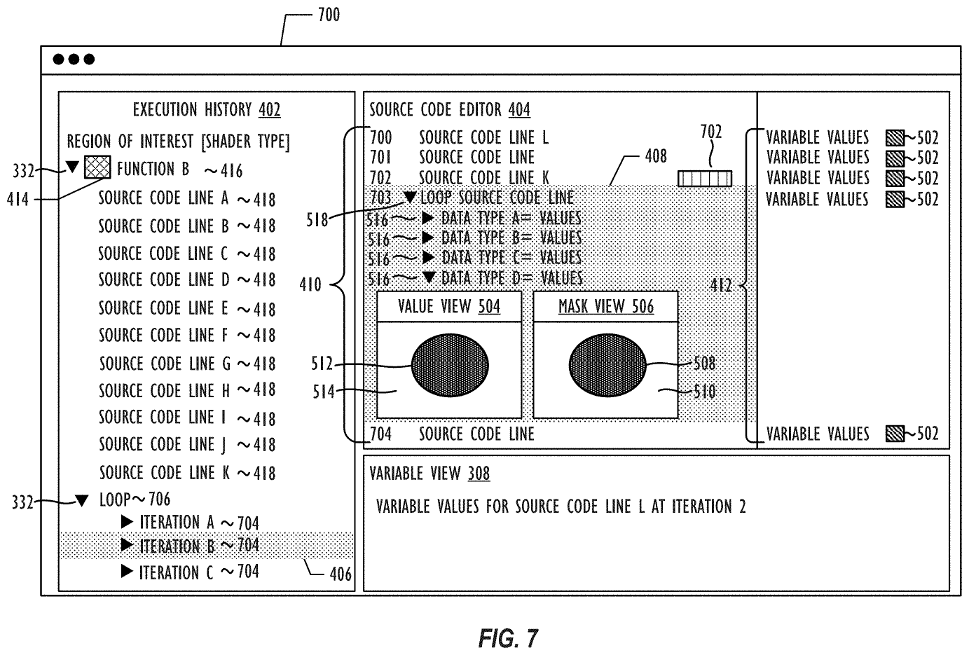

FIG. 7 illustrates another implementation of a shader GUI 700 after defining a region of interest. With reference to FIG. 1B, the shader GUI 700 corresponds to the fragment GUI 112, vertex GUI 114, and/or tessellation GUI 120. Shader GUI 700 is a window that is similar to shader GUI 500 except that shader GUI 700 depicts that loop node 706 includes iteration nodes A-C 704 as sub-categories. Iteration nodes A-C 704 are associated with same line “703” of source code 410. For shader GUI 700 to present variable values 412 for each of the iterations performed in loop node 706, the execution history window panel 402 presents a separate iteration node 704.

When a user selects one of the iteration nodes 704 within the execution history window panel 402, the source code editor window panel 404 updates source code 410 (e.g., values for data type A-D) and variable values 412 that correspond to the selected iteration. The variable view window panel 308 also updates its variable values based on the selected iteration node 704. As shown in FIG. 7, when a user selects iteration node B 704, the execution history window panel 402 presents and overlays highlight box 406 on iteration node B 704. The source code editor window panel 404 updates source code 410 and variable values 412 to correspond to iteration node B 704. If the user subsequently selects iteration node C 704, the highlight box 406 moves to iteration node C 704, and the source code editor window panel 404 updates source code 410 (e.g., values for data type A-D) and variable values 412 to correspond to iteration node C 704. The variable view window panel 308 also updates its variable values to match iteration node C 704.

As previously discussed, by selecting the source code icon 502 that corresponds to line “703” of source code 410, a viewer is able to view an expanded state of line “703” of source code 410. The mask view 506 represents a texture view that presents which graphics processor threads have executed line “703.” In FIG. 7, since line “703” corresponds to a looping or iteration function call that could have multiple executed iterations, the executed graphics processor threads 508 refer to threads that have executed previous iterations and the currently selected iteration of line “703” of source code 410. Unexecuted graphics processor threads 510 represent threads that did not execute the currently selected iteration of line “703” of source code 410. Using FIG. 7 as an example, for iteration node B 704, executed graphics processor threads 508 within mask view 506 represent threads that executed iteration nodes A and B 704 and unexecuted graphics processor threads 510 represent threads that did not execute iteration node B 704. In another example, for iteration node C 704, executed graphics processor threads 508 within mask view 506 represent threads that executed iteration nodes A-C 704, and unexecuted graphics processor threads 510 represent threads that did not execute iteration node C 704. The value view 504 represents a texture view that presents the executed thread values 512 for executed graphics processor threads 508 shown in the mask view 506.

FIG. 7 also illustrates that the source code editor window panel 404 includes a source-code inline view icon 702. The source code inline view icon 702 allows a user to select and view different execution invocation and/or iterations of a portion of source code 410. With reference to FIG. 7, source code inline view icon 702 allows a user to select and view the different executed iterations that correspond to iteration nodes A-C 704. As example, line “703” of source code 410 corresponds to iteration node B 704. A user may provide one or more user inputs to activate the source code inline view icon 702 to view variables and variable values that correspond to iteration node C 704. In another example, source code editor window panel 404 may utilize the source code inline view icon 702 to view different execution invocations of a function call node. Referring to FIG. 7, a graphics processor may have executed function call B node 416 more than once. The source code inline view icon 702 allows a user select the different execution versions for function call B node 416, which causes the source code editor window panel 404 to update variable values according to the selected execution version.

Although FIGS. 3-7 represent GUIs for shaders, GUIs 300, 400, 500, 600, and 700 could also apply to GUIs for compute kernels. As an example, the compute GUI 116 shown in FIG. 1B could have a similar layout as shader GUIs 400, 500, 600, and 700 for a selected compute kernel (e.g., threadgroup). In particular, the compute GUI 116 could have an execution history window panel 402 that is adjacent to a source code editor window panel 404 that contains variable values 412. When a user selects to view a different tread, the execution history window panel 402 and source code editor window panel 404 can be updated with execution history that matches the newly, selected graphics processor thread.

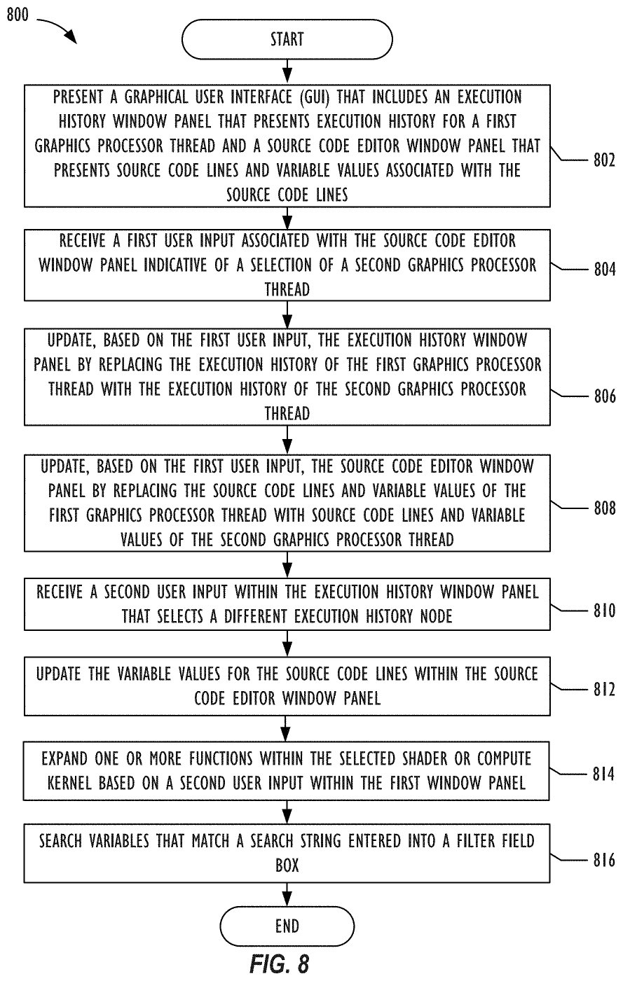

FIG. 8 depicts a flowchart illustrating a shader debugging operation 800 that visualizes execution history for a defined region of interest. To visualize execution history, operation 800 is able to generate a variety GUIs for different shader types (e.g., fragment shader or vertex shader) based on a defined region of interest. In one implementation, operation 800 may be implemented by debugger application 106 shown in FIGS. 1A and 1B. For example, blocks within operation 800 could be implemented by the frontend debugger 110 shown in FIGS. 1A and 1B.

The use and discussion of FIG. 8 is only an example to facilitate explanation and is not intended to limit the disclosure to this specific example. For example, although FIG. 8 illustrates that the blocks within operation 800 are implemented in a sequential order, operation 800 is not limited to this sequential order. For instance, one or more of the blocks, such as blocks 806 and 808, could be implemented in parallel. Additionally or alternatively, one or more blocks (e.g., block 812) may be optional such that operation 800 may not perform certain blocks each time operation 800 attempts to visualize execution history.

Operation 800 starts at block 802 and presents a GUI that includes an execution history window panel that presents execution history for a first graphics processor thread and a source code editor window panel that presents source code lines and variable values associated with the source code lines. In one or more implementations, the GUI may also include graphics API resources within the execution history window panel and/or source code editor window panel. The variable values represents values after having a graphics processor execute the source code lines. Afterwards, operation 800 moves to block 804 and receives a first user input associated with the source code editor window panel indicative of a selection of a second graphics processor thread. Using FIG. 5 as an example, operation 800 may receive a user input within the value view 504 or a mask view 506 that selects a different thread within a defined region of interest.

Operation 800 can continue to block 806 and update, based on the first user input, the execution history window panel by replacing the execution history of the first graphics processor thread with the execution history of the second graphics processor thread. As an example, because operation 800 may execute different function calls, source code lines, loops, and/or loop iterations from thread to thread, the execution history of the first graphics processor thread is different from the execution history of the second graphics processor thread. Using FIG. 4 as an example, when operation 800 receives a selection to view a different graphics processor thread, operation 800 may update execution history window panel 402 to present different function call nodes 416, source code line nodes 418 within one or more function call nodes 416, and/or other execution history nodes. Operation 800 may then move to block 808 and update, based on the first user input, the source code editor window panel by replacing the source code lines and variable values of the first graphics processor thread with source code lines and variable values of the second graphics processor thread. Referencing FIG. 4 again, operation 800 may also update the source code editor window panel 404 with different variable values 412 for each executed line of source code 410.

At block 810, operation 800 may receive a second user input within the execution history window panel that selects a different execution history node, wherein the selected execution history node corresponds to the same line of source code as the previously selected execution history node. As an example, the second user input within the execution history window panel may move the user selection from one iteration node to another iteration node within the same loop node. Afterwards, operation 800 moves to block 812 and updates the variable values for the source code lines within the source code editor window panel. Continuing with the pervious example, operation 800 updates the variable values according to the selected iteration node.

At block 814, operation 800 may also expand one or more function calls within the selected shader or compute kernel based on a second user input within the execution history window panel. Using FIG. 4 as an example, operation 800 is able to expand function call B node 416 to present as sub-categories source code line A-F nodes 418, resources A-F, and function call C and D nodes 416 based on user inputs. At block 816, operation 800 searches variables that match a search string entered into a filter field box. In one example, operation 800 is able to display the filtered results by updating the execution history window panel and presenting the execution history for a specific graphics processor thread. In instances where a user selects a new, graphics processor thread within the defined region of interest, the filter results shown in execution history window panel may also be updated based on the selection of the new, graphics processor thread.

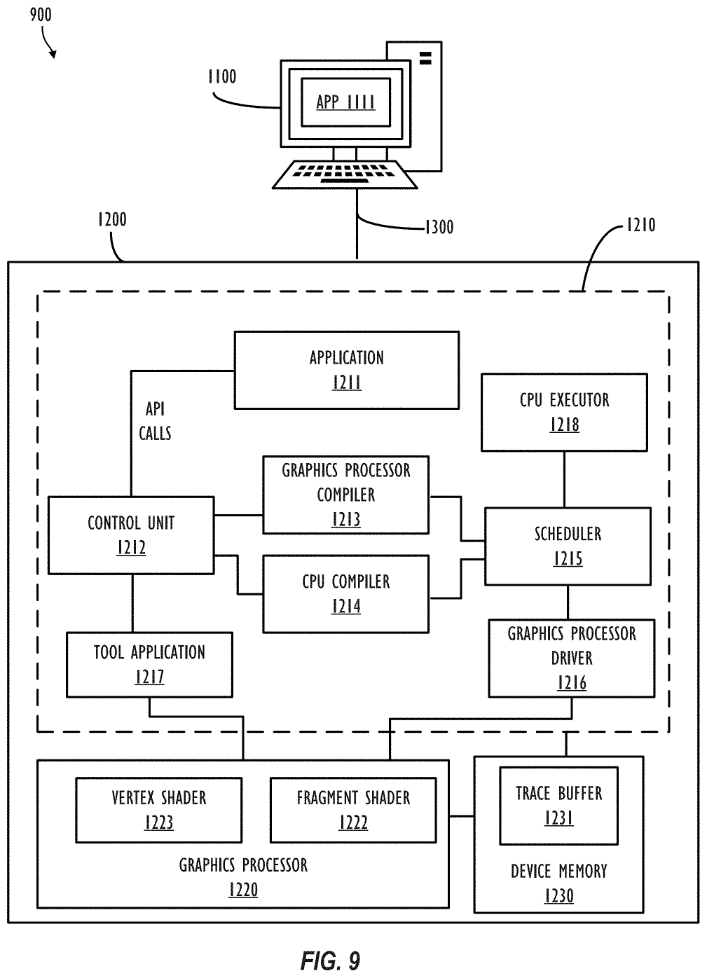

FIG. 9 demonstrates system 900, in accordance with one implementation, including host computer 1100 executing host-side component application 1111 and computing device 1200 executing device-side component application 1211 coupled through communication link 1300. Host computer 1100 may, for example, be a server, workstation, desktop, laptop, or notebook computer system. Computing device 1200 could, for example, be a smart phone, a laptop, a personal computer, a portable entertainment device or a tablet computer system.

While FIG. 9 in this disclosure describes the implementation of a shader debugger technique with respect to computing device 1200, one skilled in the art will appreciate that the shader debugger technique, or at least or portion of it, could also be implemented by host computer 1100. For example, in an implementation, host computer 1100 may send groups of one or more instructions to computing device 1200. Computing device 1200 may execute these instruction on its graphics processor 1220 and return run-time results to host computer 1100. Finally, host computer 1100 may analyze the run-time data and return shader debugging results.

Referring back to FIG. 9, computing device 1200 includes one or more data processing units. For example, computing device 1200 may include a CPU 1210 and a graphics processor 1220. Graphics processor 1220 may comprise multiple cores or processing elements designed for executing the same instruction on parallel data streams, making it more effective than general-purpose CPUs for algorithms in which processing of large blocks of data is done in parallel. Communication link 1300 may employ any desired technology, wired or wireless.

Host-side component application 1111 may be a single application, program, or code module or it may be embodied in a number of separate program modules. Likewise, device-side component application 1211 may be embodied in one or more modules. For example, the device-side component application 1211 may be a graphic application conveying description of a graphic scene by invoking API calls to control unit 1212 in order to render an image for display. APIs are developed by vendors and standards organizations to make graphic data-parallel tasks easier to program.

The device-side component application 1211 may be written in any programming language such as C, C++, Java, Fortran, and MatLab. The operations demanded by the device-side component application 1211 are then interpreted by the control unit 1212 for execution. In an implementation, the control unit 1212 may map the API calls to operations that are understood by the computing device 1200. Subsequently, the source code is communicated to the compilers 1213 and 1214 to generate binary code for execution on the graphics processor 1220 and CPU executor 1218. More specifically, the graphics processor compiler 1213 produces the compiled program, also referred as shader program or shader binary, which is executable on the graphics processor 1220.

The scheduler 1215 arranges for the execution of the sequences of compiled programs on the corresponding processing units. Graphics processor driver 1216 provides access to graphics processor resources such as graphics processor shader engines. Each shader engine executes instructions in the shading program to perform image rendering operations. In an implementation according to FIG. 9, exemplary shader engines vertex shader 1223 and fragment shader 1222 are illustrated. In an implementation, vertex shader 1223 handles the processing of individual vertices and vertex attribute data. Fragment shader 1222 processes a fragment generated by the rasterization into a set of colors and a single depth value. In an implementation, a frame of the graphic data rendered by shader engines are stored in a frame buffer for display (not shown).

In an implementation, tool application 1217 communicates with graphics processor driver 1216 in order to determine resources available for collecting execution history during the execution of a shader program by graphics processor 1220. The tool application 1217 can represent the graphics processing replayer 122 that collects data for shader debugging purposes within a trace buffer 1231 as previously explained. In an implementation, trace buffer 1231 is part of the device memory 1230 but could also be an on-chip memory on graphics processor 1220.

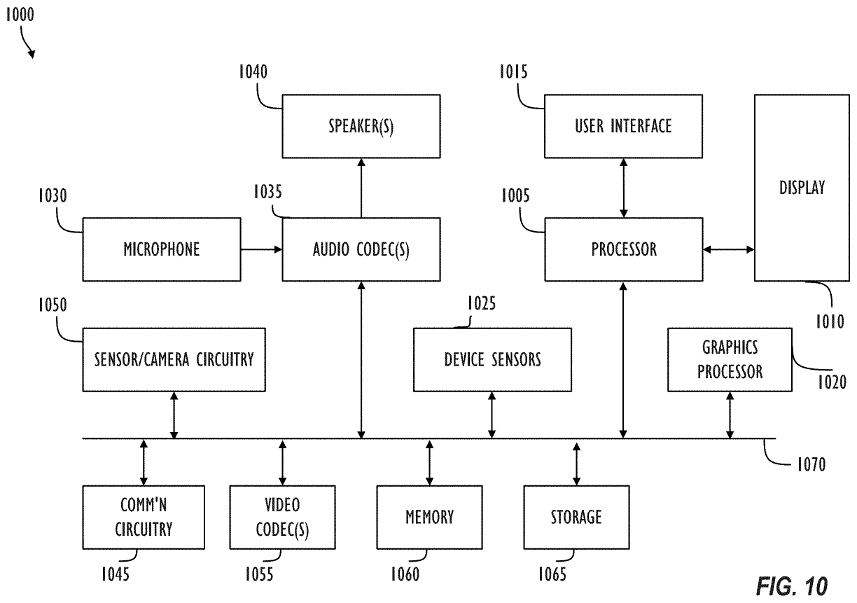

Referring to FIG. 10, a simplified functional block diagram of illustrative electronic device 1000 of a host component 104 and/or device component 102. Electronic device 1000 may include processor 1005, display 1010, user interface 1015, graphics processor 1020, device sensors 1025 (e.g., proximity sensor/ambient light sensor, accelerometer and/or gyroscope), microphone 1030, audio codec(s) 1035, speaker(s) 1040, communications circuitry 1045, sensor and camera circuitry 1050, video codec(s) 1055, memory 1060, storage 1065, and communications bus 1070. Electronic device 1000 may be, for example, a digital camera, a personal digital assistant (PDA), personal music player, mobile telephone, server, notebook, laptop, desktop, or tablet computer. More particularly, the disclosed techniques may be executed on a device that includes some or all of the components of electronic device 1000.

Processor 1005 may execute instructions necessary to carry out or control the operation of many functions performed by a multi-functional electronic device 1000 (e.g., such as shader debugging). Processor 1005 may, for instance, drive display 1010 and receive user input from user interface 1015. User interface 1015 can take a variety of forms, such as a button, keypad, dial, a click wheel, keyboard, display screen and/or a touch screen. Processor 1005 may be a system-on-chip such as those found in mobile devices and include a dedicated graphics processor. Processor 1005 may represent multiple CPUS and may be based on reduced instruction-set computer (RISC) or complex instruction-set computer (CISC) architectures or any other suitable architecture and each may include one or more processing cores. Graphics processor 1020 may be special purpose computational hardware for processing graphics and/or assisting processor 1005 process graphics information. In one implementation, graphics processor 1020 may include one or more programmable GPUs, where each such unit has multiple cores.

Sensor and camera circuitry 1050 may capture still and video images that may be processed to generate images in accordance with this disclosure. Sensor in sensor and camera circuitry 1050 may capture raw image data as red, green, and blue (RGB) data that is processed to generate an image. Output from sensor and/or camera circuitry 1050 may be processed, at least in part, by video codec(s) 1055 and/or processor 1005 and/or graphics processor 1020, and/or a dedicated image-processing unit incorporated within sensor and/or camera circuitry 1050. Images so captured may be stored in memory 1060 and/or storage 1065. Memory 1060 may include one or more different types of media used by processor 1005, graphics processor 1020, and sensor and/or camera circuitry 1050 to perform device functions. For example, memory 1060 may include memory cache, read-only memory (ROM), and/or random access memory (RAM). Storage 1065 may store media (e.g., audio, image and video files), computer program instructions or software, preference information, device profile information, and any other suitable data. Storage 1065 may include one more non-transitory storage mediums including, for example, magnetic disks (fixed, floppy, and removable) and tape, optical media such as compact disc-ROMs (CD-ROMs) and digital video disks (DVDs), and semiconductor memory devices such as Electrically Programmable Read-Only Memory (EPROM), and Electrically Erasable Programmable Read-Only Memory (EEPROM). Memory 1060 and storage 1065 may be used to retain computer program instructions or code organized into one or more modules and written in any desired computer programming language. When executed by, for example, processor 1005 such computer program code may implement one or more of the methods described herein.

It is to be understood that the above description is intended to be illustrative, and not restrictive. The material has been presented to enable any person skilled in the art to make and use the claimed subject matter as described herein, and is provided in the context of particular implementations, variations of which will be readily apparent to those skilled in the art (e.g., some of the disclosed implementations may be used in combination with each other). In addition, some of the described operations may have their individual steps performed in an order different from, or in conjunction with other steps, than presented herein. More generally, if there is hardware support some operations described in conjunction with FIG. 8 may be performed in parallel.

At least one implementation is disclosed and variations, combinations, and/or modifications of the implementation(s) and/or features of the implementation(s) made by a person having ordinary skill in the art are within the scope of the disclosure. Alternative implementations that result from combining, integrating, and/or omitting features of the implementation(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Many other implementations will be apparent to those of skill in the art upon reviewing the above description. The scope of the disclosure therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A non-transitory program storage device, readable by a processor and comprising instructions stored thereon to cause the processor to:
present a graphical user interface (GUI) that comprises:
a first window panel that presents execution history of a first graphics processor thread for a specified shader type, wherein the first window panel includes a first set of function calls that represent source code function calls executed according to the execution history of the first graphics processor thread; and
a second window panel that presents a first set of shader source code lines and a first set of variable values, wherein the first set of shader source code lines and the first set of variable values correspond to the execution history of the first graphics processor thread; and
receive a first user input associated with the second window panel indicative of a selection of a second graphics processor thread;
update, based on the first user input, the first window panel by replacing the execution history of the first graphics processor thread with execution history of the second graphics processor thread; and
update, based on the first user input, the second window panel by replacing the first set of shader source code lines with a second set of shader source code lines.

2. The non-transitory program storage device of claim 1, wherein instructions further cause the processor to:
receive a second user input corresponding to the first window panel; and
expand, based on the second user input, a first function call that presents a list of executed source code lines that executed for the first function call by the second graphics processor thread.

3. The non-transitory program storage device of claim 1, wherein each function call of the first set of function calls include executed source code lines, executed loops, and executed loop iterations for the first graphics processing thread.

4. The non-transitory program storage device of claim 1, wherein the second set of shader source code lines includes a second set of variable values that correspond to the execution history of the second graphics processor thread, and wherein instructions further cause the processor to:
receive a second user input corresponding to the second window panel; and
expand based on the second user input, a first variable of the second set of variable values.

5. The non-transitory program storage device of claim 4, wherein expanding the first variable generates a first texture view that presents variables values for a plurality of other graphics processor threads that executed the first variable and a second texture view presents the other graphics processor threads that executed the first variable.

6. The non-transitory program storage device of claim 5, wherein the instructions further cause the processor to:
receive a third user input corresponding to the first texture view or the second texture view indicative of a selection of a third graphics processor thread; and
update, based on the third user input, the second window panel by replacing the second set of shader source code lines with a third set of shader source code lines and replacing a second set of variable values associated with the second set of shader source code lines with a third set of variables values associated with the third set of shader source code lines.

7. The non-transitory program storage device of claim 1, wherein the instructions that cause the processor to update the first window panel further comprise instructions that cause the processor to cause display of a second set of function calls within first window panel, the second set of function calls representing function calls executed according to the execution history of the second graphics processor thread.

8. The non-transitory program storage device of claim 1, wherein the GUI further comprises a filter field box for searching one or more executed variables, function name, contents within the second set of source code lines, or combinations thereof for the second graphics processor thread.

9. A system comprising:
memory; and
a processor operable to interact with the memory, and configured to:
receive, for a first graphical user interface (GUI), a first user input that debugs a region of interest that is based on a selected draw call and a selected shader type for a graphics frame;
transition to a second GUI that comprises:
a first window panel that presents execution history of a first graphics processor thread associated with the region of interest; and
a second window panel that presents a first set of shader source code lines executed by the first graphics processor thread, a first set of variables, and variable values for the first set of variables;
receive a second user input to switch to a second graphics processor thread associated with the region of interest; and
update, based on the second user input, the first window panel and the second window panel within the second GUI.

10. The system of claim 9, wherein the processor is configured to update the first window panel by replacing the execution history of the first graphics processor thread with execution history of the second graphics processor thread.

11. The system of claim 9, wherein the processor is configured to update the second window panel by replacing the first set of shader source code lines with a second set of shader source code lines.

12. The system of claim 11, wherein the processor is configured to update the second window panel by replacing variable values for the first set of variables with variable values with a second set of variables found in the second graphics processor thread.

13. The system of claim 11, wherein the processor is further configured to:
receive a third user input corresponding to the second window panel; and
expand, based on the third user input, a shader source code line within the second set of shader source code lines.

14. The system of claim 13, wherein the processor is further configured to:
receive a fourth user input corresponding to the second window panel; and
expand, based on the fourth user input, a variable within the shader source code line of the second set of shader source code lines,
wherein expansion of the variable generates a first texture view that presents variables values for a plurality of other graphics processor threads that executed the variable and a second texture view the presents the other graphics processor threads that executed variable.

15. The system of claim 14, wherein the processor is further configured to
receive a fifth user input corresponding to the first texture view or the second texture view indicative of a selection of a third graphics processor thread; and
update, based on the fifth user input, the second window panel by replacing variable values associated with the second graphics processor thread with variable values associated with the third graphics processor thread.

16. The system of claim 9, wherein the processor is further configured to:
receive a third user input corresponding to the first window panel; and
expand, based on the third user input, a first function call executed by the second graphics processor thread, wherein expanding the first function call presents a list of source code lines that executed within the first function call.

17. A computer-implemented method comprising:
presenting a first graphical user interface (GUI) for navigating through an executed graphics frame;
receive, for a first graphical user interface (GUI), a first user input that debugs a region of interest that is based on a selected draw call and a selected shader type for a graphics frame;
presenting, in response to receiving the first user input, a second GUI that comprises:
an execution history window panel that presents execution history of a first graphics processor thread associated with the region of interest; and
a source code editor window panel that presents a first set of shader source code lines executed by the first graphics processor thread, a first set of variables, and variable values for the first set of variables;
receiving a second user input with the second GUI to switch to a second graphics processor thread associated with the region of interest; and
updating, based on the second user input, the execution history window panel by replacing the execution history of the first graphics processor thread with execution history of the second graphics processor thread; and
updating, based on the second user input, the source code editor window panel by replacing the first set of shader source code lines with a second set of shader source code lines and variable values for the first set of variables with variable values for a second set of variables.

18. The method of claim 17, further comprising:
receiving a third user input corresponding to the execution history window panel; and
expanding, based on the third user input, a first function call that presents a list of source code lines that that executed for the first function call by the second graphics processor thread.

19. The method of claim 17, further comprising:
receiving a third user input corresponding to the source code editor window panel; and
expanding, based on the third user input, a first variable of a second set of variable values, wherein the second set of shader source code lines includes the second set of variable values.

20. The method of claim 19, wherein expanding the first variable generates a first texture view that presents variables values for a plurality of other graphics processor threads that executed the first variable and a second texture view the presents the other graphics processor threads that executed the first variable.
